(19) United States
(12) Patent Application Publication
(10) Pub. No.: US 2024/0242718 A1
(43) Pub. Date: Jul. 18, 2024

(54) DIALOGUE APPARATUS, DIALOGUE METHOD, AND PROGRAM

(71) Applicant: NIPPON TELEGRAPH AND TELEPHONE CORPORATION, Tokyo (JP)

(72) Inventors: Ryuichiro HIGASHINAKA, Tokyo (JP); Masahiro MIZUKAMI, Tokyo (JP); Ko MITSUDA, Tokyo (JP)

(73) Assignee: NIPPON TELEGRAPH AND TELEPHONE CORPORATION, Tokyo (JP)

(21) Appl. No.: 18/562,294

(22) PCT Filed: May 24, 2021
(86) PCT No.: PCT/JP2021/019515

§ 371 Date: Nov. 18, 2023

(51) Int. Cl. G10L 15/22; G10L 13/027

(52) U.S. Cl. CPC G10L 15/22; G10L 13/027

(57) ABSTRACT

Even when there is a small amount of question response data, a highly accurate response is performed to a user utterance. A question response collection unit (12) collects question response data including a state of a dialog, a question, and a response. A template generation unit (13) generates an utterance template associated with the state on the basis of the question response data. An utterance generation unit (14) generates a system utterance by using the utterance template associated with a state of a current dialog. An utterance presentation unit (15) presents the system utterance to a user. An utterance reception unit (16) receives a user utterance uttered by the user. A state transition unit (17) causes the state of the current dialog to transition on the basis of the user utterance.

### TECHNICAL FIELD

The present invention relates to a technology for performing dialog with a human by using a natural language.

### BACKGROUND ART

With progress of voice recognition technology, voice synthesis technology, and the like, a dialog system has been widely used that performs dialog with a human by using a natural language. Dialog systems are generally classified into task-oriented dialog systems for achieving predetermined tasks and non-task-oriented dialog systems (also generally referred to as “chat dialog systems”) that are intended for dialog itself. The task-oriented dialog systems and the non-task-oriented dialog systems are described in detail in Non Patent Literature 1.

The task-oriented dialog systems are widely used as a personal assistants on smartphones, or smart speakers. As a main method of configuring the task-oriented dialog systems, there are a state transition-based configuration method and a frame-based configuration method.

In a state transition-based dialog system, a dialog is classified into several states, and a task is performed by transitioning between the states. For example, in a case of a dialog system that performs weather information guidance, a state of asking a place name (start state), a state of asking a date, a state of providing weather information (end state), and the like are defined. When the dialog is started, the state transitions to the state of asking the place name defined as the start state. In the state of asking the place name, when a user utters the place name, the state transitions to the state of asking the date. In the state of asking the date, when the user utters the date, the state transitions to the state of providing the weather information. In the state of providing the weather information, the weather information is transmitted to the user by referring to an external database on the basis of information on the place name and the date that have been heard so far, and the dialog is ended.

In a frame-based dialog system, when an utterance is input by the user, an utterance responding to the utterance of the user is output through processes of utterance understanding, dialog control, and utterance generation. The utterance understanding converts the user's input into an internal expression of the system. Generally, a dialog act is used as the internal expression. The dialog act is a semantic expression including a symbol (dialog act type) representing an utterance intention and an attribute value pair accompanying the symbol. For example, in the case of the dialog system that performs the weather information guidance, from a user utterance “Please tell me the weather for tomorrow”, a dialog act type of “transmission of the date” and an attribute value pair of “date=tomorrow” are obtained. The dialog act updates a “frame” that is an information structure inside the system. In the frame, information is input heard from the user from the start of the dialog to that time. In the example of the dialog system that performs the weather information guidance, the frame includes, for example, slots of a “place name” and a “date”. By the above dialog act, “tomorrow” is embedded in the slot of “date”. The dialog control generates an action to be performed next by the dialog system on the basis of the frame updated. Here, the action is often expressed as a dialog act. For example, if the slot of “place name” is empty, a dialog act having a dialog act type of “question about a place name” is generated. The dialog act of the system is converted into a natural language (for example, “Weather of where?”) by utterance generation and output toward the user.

A plurality of methods has been proposed as a method of constructing a non-task-oriented dialog system. For example, there are a method based on a manually created response rule, an example-based method of searching for a system utterance for a user utterance from a large-scale text by using a text search method, a method of generating a response utterance by a deep learning model on the basis of large-scale dialog data, and the like.

It is important to impart character-ness to both the task-oriented dialog system and the non-task-oriented dialog system. This is because the character-ness makes it possible to give a human-like familiarity. To impart the character-ness, it is necessary to make an utterance content and a way of speaking consistent, and many methods for that purpose have been studied. For example, as in Non Patent Literatures 2 and 3, there has been proposed a method of converting a word ending or the like to match a character, or generating an utterance having consistent character-ness by referring to predetermined profile information.

To construct a dialog system having the character-ness, it is desirable to prepare utterance data of a target character and construct an utterance generation unit on the basis of the utterance data. As an efficient method of collecting such utterance data, there has been proposed a method of collecting questions and responses regarding characters from online users (see, for example, Non Patent Literature 4). Specifically, questions for the target character are described by an online user, and responses to the questions are posted by the online user. The online user has a fun of being able to ask a question to a character in which the online user is interested, and at the same time, has a fun of imagination of being able to respond by completely playing a role of the character in which the online user is interested. Non Patent Literature 4 describes that according to this method, it is possible to efficiently collect character-like utterances from online users. In addition, it is described that a chat dialog system having high character-ness can be constructed by using a pair of collected questions and responses (hereinafter, also referred to as “question response data”).

### CITATION LIST

### Non Patent Literature

Non Patent Literature 1: Ryuichiro Higashinaka, Michimasa Inaba, Masahiro Mizukami, “Dialog System Using Python”, Ohmsha, Ltd., 2020
Non Patent Literature 2: Miyazaki, Chiaki, et al, “Towards an entertaining natural language generation system: Linguistic peculiarities of Japanese fictional characters,” Proceedings of the 17th Annual Meeting of the Special Interest Group on Discourse and Dialogue, 2016.
Non Patent Literature 3: Saizheng Zhang, Emily Dinan, Jack Urbanek, Arthur Szlam, Douwe Kiela, Jason Weston, “Personalizing Dialogue Agents: I have a dog, do you have pets too?”, Proceedings of the 56th Annual Meeting of the Association for Computational Linguistics, 2018.
Non Patent Literature 4: Ryuichiro Higashinaka, Masahiro Mizukami, Hidetoshi Kawabata, Emi Yamaguchi, Noritake Adachi, Junji Tomita, “Role play-based question-answering by real users for building chatbots with consistent personalities,” Proceedings of the 19th Annual SIGdial Meeting on Discourse and Dialogue, 2018.

### SUMMARY OF INVENTION

### Technical Problem

Even in an advanced dialog system, there is a possibility that the advanced dialog system is not used unless it has no character-ness that makes the user want to have dialog. However, in a case where it is desired to impart the character-ness to an existing dialog system, it is necessary for a system developer to recreate the utterance generation unit in accordance with the target character. In a case where there are many online users, a large number of questions and responses thereof can be collected by using the method of Non Patent Literature 4, but in a case where there are few online users for the character, a large number of question response data cannot be collected. A dialog system constructed on the basis of a small number of question response data has a problem of low response capability. In addition, in a case where the question response data is collected from online users and applied to the dialog system, even if a large amount of data can be collected, there is a problem that interaction cannot be performed that surpasses interaction having one question and one response. For example, it is not possible to implement a dialog system based on a context in which some information is heard and response is performed.

In view of the above technical problems, an object of the present invention is to perform interaction that surpasses interaction having one question and one response by using question response data and to present a highly accurate system utterance even when there is a small amount of question response data.

### Solution to Problem

A dialog device of a first aspect of the present invention includes: a question response collection unit that collects question response data including a state of a dialog, a question, and a response; a template generation unit that generates an utterance template associated with the state on the basis of the question response data; an utterance generation unit that generates a system utterance by using the utterance template associated with a state of a current dialog; an utterance presentation unit that presents the system utterance to a user; an utterance reception unit that receives a user utterance uttered by the user; and a state transition unit that causes the state of the current dialog to transition on the basis of the user utterance.

A dialog device of a second aspect of the present invention includes: a question response collection unit that collects question response data including a dialog act representing an utterance intention, a question, and a response; a template generation unit that generates an utterance template associated with the dialog act on the basis of the question response data; an utterance generation unit that generates a system utterance by using the utterance template associated with a dialog act to be performed next; an utterance presentation unit that presents the system utterance to a user; an utterance reception unit that receives a user utterance uttered by the user; and a dialog control unit that determines the dialog act to be performed next on the basis of the user utterance.

A dialog device of a third aspect of the present invention includes: a question response collection unit that collects paraphrase data including an utterance and an utterance obtained by paraphrasing the utterance; a conversion model generation unit that learns an utterance conversion model that uses an utterance as an input and outputs an utterance obtained by paraphrasing the utterance, by using the paraphrase data; an utterance generation unit that generates a system utterance; an utterance conversion unit that inputs the system utterance into the utterance conversion model to obtain a converted system utterance obtained by paraphrasing the system utterance; and an utterance presentation unit that presents the converted system utterance to a user.

### Advantageous Effects of Invention

According to the present invention, it is possible to perform interaction that surpasses interaction having one question and one response by using question response data and to present a highly accurate system utterance even when there is a small amount of question response data.

### BRIEF DESCRIPTION OF DRAWINGS

FIG. 1 is a diagram illustrating a functional configuration of a dialog device of a first embodiment.

FIG. 2 is a diagram illustrating a processing procedure of a dialog method of the first embodiment.

FIG. 3 is a diagram illustrating a functional configuration of a dialog device of a second embodiment.

FIG. 4 is a diagram illustrating a processing procedure of a dialog method of the second embodiment.

FIG. 5 is a diagram illustrating a functional configuration of a dialog device of a third embodiment.

FIG. 6 is a diagram illustrating a processing procedure of a dialog method of the third embodiment.

FIG. 7 is a diagram illustrating a functional configuration of a computer.

### DESCRIPTION OF EMBODIMENTS

Hereinafter, embodiments of the invention will be described in detail. Note that, in the drawings, components having the same function are denoted by the same reference numerals, and redundant description will be omitted.

### SUMMARY OF INVENTION

In the present invention, a pair of a question and a response associated with a state or a dialog act is collected by allowing an online user to post a corresponding question and response to the state or the dialog act that is an internal expression of a dialog system, and utterance generation is performed on the basis of the collected question and response, whereby accuracy of a system utterance is improved. If a specific character-like utterance is collected from the online user, it is possible to impart character-ness to any dialog system. In addition, for a response of a predetermined dialog system, an utterance that is a character-like paraphrase is collected from the online user, and utterance generation is performed on the basis of a pair of a current system utterance and a character-like utterance, whereby it is possible to impart the character-ness to any dialog system. As a result, even in a case where the dialog system executes a dialog that transitions between a plurality of states or dialog acts, by using a pair of a question and a response associated with each state or each dialog act, it is possible to perform an appropriate response depending on a situation and to achieve a consistent dialog that surpasses a dialog having one question and one response and has the character-ness.

In the present invention, an utterance is collected from the online user for each of a state, a dialog act, and an utterance, but these have different restrictions. The state represents a situation in which the dialog system is placed, and there may be a plurality of semantic contents that can be uttered by the dialog system in the situation. However, an utterance collected for a dialog act is restricted by a semantic content of the dialog act. For example, when a dialog act of “transmission of weather information” is given, a semantic content of an utterance collected from the online user needs to transmit weather information. On the other hand, in a case of the state, there is a case where the semantic content is not restricted as in an “initial state of a dialog”. In a case of collecting a paraphrase for an utterance, restriction is more strict since a base expression is also defined. Strict restriction leads to less freedom of the online user and efficient collection of only a paraphrase necessary for achieving character-likeness.

In each embodiment, when a predetermined character (hereinafter, referred to as a “character A”) is given, an existing task-oriented dialog system is configured to be able to respond like the character A. Here, as the existing task-oriented dialog system, a dialog system is assumed that guides weather information. In existing dialog systems that guide weather information, there are a state transition-based dialog system and a frame-based. A first embodiment is an example of a state transition-based task-oriented dialog system. A second embodiment and a third embodiment are examples of a frame-based task-oriented dialog system. In each embodiment, a task-oriented dialog system is described as a target, but the present invention is also applicable to a non-task-oriented dialog system as long as the dialog system has a state or a dialog act.

In each embodiment, as the character A, a character is assumed with a setting of an elementary school boy. In addition, a place is prepared for collecting questions and responses from online users for the character A. This is specifically a website (hereinafter, referred to as a “question response collection site”). On the question response collection site, a user who is interested in the character A can post a question for the character A or a response performed by completely playing a role of the character A. When a question is created, a tag representing a state or a dialog act can be input as attached information.

### First Embodiment

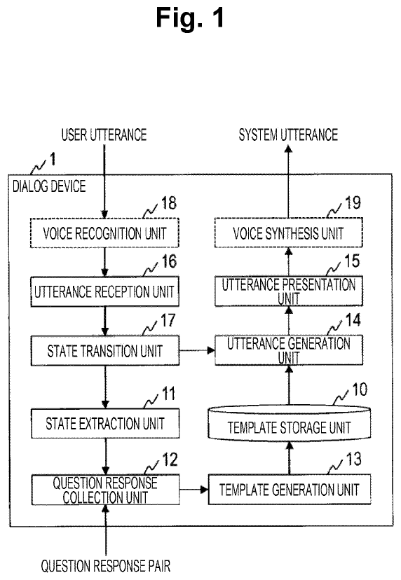

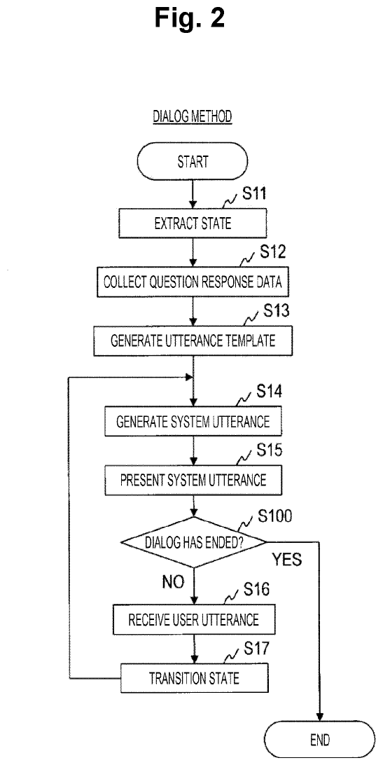

The first embodiment of the present invention is an example of a dialog device and a dialog method for presenting a system utterance for responding like the character A to an input user utterance in the state transition-based task-oriented dialog system. As illustrated in FIG. 1, a dialog device 1 of the first embodiment includes, for example, a template storage unit 10, a state extraction unit 11, a question response collection unit 12, a template generation unit 13, an utterance generation unit 14, an utterance presentation unit 15, an utterance reception unit 16, and a state transition unit 17. The dialog device 1 may include a voice recognition unit 18 and a voice synthesis unit 19. The dialog device 1 executes processing of each of steps illustrated in FIG. 2, whereby the dialog method of the first embodiment is implemented.

A dialog device is a special device configured such that a special program is read by a known or dedicated computer including, for example, a central processing unit (CPU), a main storage device (random access memory (RAM)), and the like. The dialog device executes each of pieces of processing under control of the central processing unit, for example. Data input to the dialog device and data obtained in each of the pieces of processing are stored in, for example, the main storage device, and the data stored in the main storage device is read to the central processing unit as necessary and used for other processing. At least some of processing units included in the dialog device may be configured by hardware such as an integrated circuit. Each of storage units included in the dialog device can be configured by, for example, a main storage device such as a random access memory (RAM), an auxiliary storage device configured by a hard disk, an optical disk, or a semiconductor memory device such as a flash memory, or middleware such as a relational database or a key value store.

Hereinafter, the dialog method executed by the dialog device 1 of the first embodiment will be described in detail with reference to FIG. 2.

The dialog device 1 uses a text representing a content of a user utterance as an input and outputs a text representing a content of a system utterance for responding to the user utterance, thereby executing a dialog with a user as a dialog partner. The dialog executed by the dialog device 1 may be performed on a text basis or on a voice basis.

When the dialog is executed on a text basis, the dialog between the user and the dialog device 1 is executed by using a dialog screen displayed on a display unit (not illustrated) such as a display included in the dialog device 1. The display unit may be installed in a housing of the dialog device 1 or may be installed outside the housing of the dialog device 1 and connected to the dialog device 1 by a wired or wireless interface. The dialog screen includes at least an input area for inputting a user utterance and a display area for presenting a system utterance. The dialog screen may include a history area for displaying a history of the dialog performed from the start of the dialog to the present, or the history area may also serve as the display area. The user inputs the text representing the content of the user utterance into the input area of the dialog screen. The dialog device 1 displays the text representing the content of the system utterance in the display area of the dialog screen.

In a case where the dialog is executed on a voice basis, the dialog device 1 further includes the voice recognition unit 18 and the voice synthesis unit 19. In addition, the dialog device 1 includes a microphone and a speaker (not illustrated). The microphone and the speaker may be installed in the housing of the dialog device 1 or may be installed outside the housing of the dialog device 1 and connected to the dialog device 1 by a wired or wireless interface. In addition, the microphone and the speaker may be mounted on an android imitating a human or a robot imitating an animal or a fictitious character. In this case, the android or the robot may include the voice recognition unit 18 and the voice synthesis unit 19, and the dialog device 1 may be configured to input and output the text representing the content of the user utterance or the system utterance. The microphone collects an utterance uttered by the user and outputs a voice representing the content of the user utterance. The voice recognition unit 18 uses the voice representing the content of the user utterance as an input, and outputs the text representing the content of the user utterance that is a voice recognition result for the voice. The text representing the content of the user utterance is input to the utterance reception unit 16. The text representing the content of the system utterance output by the utterance presentation unit 15 is input to the voice synthesis unit 19. The voice synthesis unit 19 uses the text representing the content of the system utterance as an input, and outputs a voice representing the content of the system utterance obtained as a result of voice synthesis of the text. The speaker emits the voice representing the content of the system utterance.

In step S11, the state extraction unit 11 acquires a list of states defined in the inside (for example, the state transition unit 17) of the dialog device 1, and outputs the acquired list of states to the question response collection unit 12. In the present embodiment, it is assumed that three states of a “state of asking a place name”, a “state of asking a date”, and a “state of providing weather information” are acquired.

In step S12, the question response collection unit 12 receives the list of states from the state extraction unit 11, collects question response data associated with each state from the online user, and outputs the collected question response data to the template generation unit 13. Specifically, first, the question response collection unit 12 adds each state as a tag to the question response collection site and makes the tag selectable on a posting screen. The online user selects a tag in any state on the question response collection site, and inputs a question that the character A would ask in the state and a response to the question. As a result, the question response collection unit 12 can acquire the question response data tagged with the state. For example, as a question about the “state of asking a place name”, utterances are collected such as “Weather of where do you want to ask?” and “Of where?”. As a question of the “state of asking a date”, utterances are collected such as “When?” and “What day?”. In the “state of providing weather information”, utterances are collected such as “###!”. However, ### is a placeholder to be filled with weather information extracted from a weather information database each time in the utterance generation unit 14.

In step S13, the template generation unit 13 receives the question response data from the question response collection unit 12, constructs an utterance template from the question response data associated with each state, and stores the utterance template in the template storage unit 10. The utterance template is a template for an utterance associated with each state of the state transition model. These are used at the time of transition to the state. Usually, it is assumed that a question included in the question response data is used as the utterance template, but a response may be used as the utterance template. Which one of the question and the response included in the question response data is used as the utterance template only needs to be determined in advance on the basis of a content of the state. For example, the utterance template for the “state of asking a place name” is “Where is the place?”, the utterance template for the “state of asking a date” is “What day?”, and the utterance template for the “state of providing weather information” is “Today's weather is ###”. Since the utterance template is simply a pair of a state name and an utterance, the utterance template can be constructed by selecting a state and an utterance associated with the state from the collected question response data.

In step S14, the utterance generation unit 14 uses a state of a current dialog as an input, acquires an utterance template associated with the state of the current dialog from utterance templates stored in the template storage unit 10, generates the text representing the content of the system utterance by using the acquired utterance template, and outputs the generated text representing the content of the system utterance to the utterance presentation unit 15. The state of the current dialog as an input is a predetermined start state (here, the “state of asking a place name”) in a case of the first execution from the dialog start, and is a state after the transition output by the state transition unit 17 described later in a case of the second and subsequent executions. In a case where a placeholder is included in the utterance template, information corresponding to the placeholder is acquired from a predetermined database, and the acquired information is embedded in a placeholder of the utterance template, whereby the text representing the content of the system utterance is generated. For example, in a case of the utterance template “Today's weather is ###”, the weather information is acquired from the weather information database (here, it is assumed to be “sunny sometimes cloudy”), and “Today's weather is sunny sometimes cloudy” obtained by replacing ### with “sunny sometimes cloudy” is the text representing the content of the system utterance.

In step S15, the utterance presentation unit 15 receives the text representing the content of the system utterance from the utterance generation unit 14, and presents the text representing the content of the system utterance to the user by a predetermined method. In a case where the dialog is executed on a text basis, the text representing the content of the system utterance is output to the display unit of the dialog device 1. In a case where the dialog is executed on a voice basis, the text representing the content of the system utterance is input to the voice synthesis unit 18, and a voice representing the content of the system utterance output by the voice synthesis unit 18 is reproduced from a predetermined speaker.

In step S100, the dialog device 1 determines whether or not the current dialog has ended. In a case where it is determined that the current dialog has not ended (NO), the processing proceeds to step S16. In a case where it is determined that the current dialog has ended (YES), the processing is ended, and waiting is performed until the next dialog starts. Dialog end determination only needs to be performed by determining whether or not the current state is a predefined end state (here, the “state of providing weather information”).

In step S16, the utterance reception unit 16 uses the text representing the content of the user utterance input to the dialog device 1 (or output by the voice recognition unit 18) as an input, and outputs the text representing the content of the user utterance to the state transition unit 17.

In step S17, the state transition unit 17 receives the text representing the content of the user utterance from the utterance reception unit 16, analyzes the content of the user utterance, causes the state of the current dialog to transition on the basis of the analysis result, and outputs the state after the transition to the utterance generation unit 14. For example, in the “state of asking a place name”, in a case where a place name is included in the user utterance, the place name is acquired, and then the state transitions to the next “state of asking a date”. In the “state of asking a date”, in a case where a date is included in the user utterance, the date is acquired, and then the state transitions to the next “state of providing weather information”. Determination of whether or not a place name is included in the user utterance only needs to be performed by determining whether or not a place name matching a list of place names prepared in advance is included in the text representing the content of the user utterance, by character string matching. The same applies to the date. In addition, determination of whether or not a place name and a date are included in the user utterance may be determined by performing a unique expression extraction technology based on a sequential labeling method such as conditional random fields and extracting the place name and the date.

Thereafter, the dialog device 1 returns the processing to step S14, and presents the system utterance associated with the state after the transition. The dialog device 1 executes the dialog with the user by repeating presentation of the system utterance (steps S14 and S15) and reception of the user utterance (steps S16 and S17) until it is determined in step S100 that the dialog has ended.

### Specific Example of First Embodiment

A specific example of the dialog executed by the dialog device 1 of the first embodiment will be described below. According to the first embodiment, it is possible to construct a state transition-based task-oriented dialog system for guiding weather information with a predetermined character-like utterance as described below. Note that a description in parentheses in the system utterance represents a state at that time.

System: Weather of where do you want to ask? (state of asking a place name)
User: It's Tokyo.
System: When? (state of asking a date)
User: It's tomorrow.
System: It's sunny! (state of providing weather information)

Note that it is assumed that a plurality of utterances is collected for each state from the online user. Thus, the utterance template generation unit 13 dynamically generates an utterance template for each dialog, whereby it is also possible to cause various types of phrasing that are typical in the character A to be performed. As a result, it is possible to implement a task-oriented dialog system that is more human-like, familiar, and expressive.

### Second Embodiment

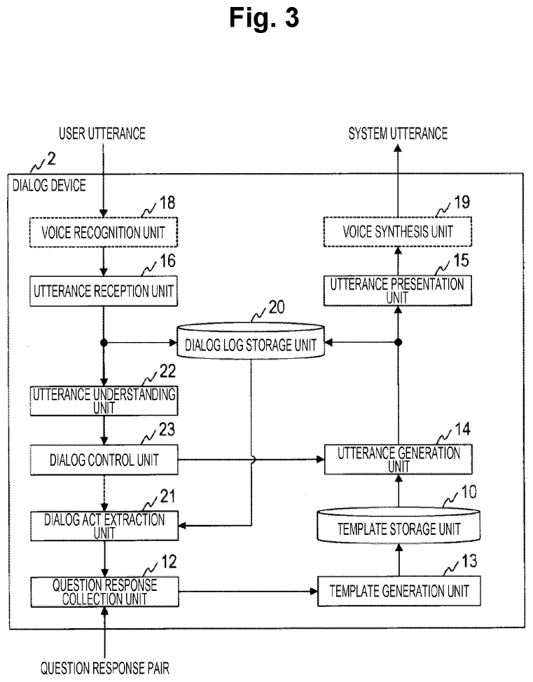

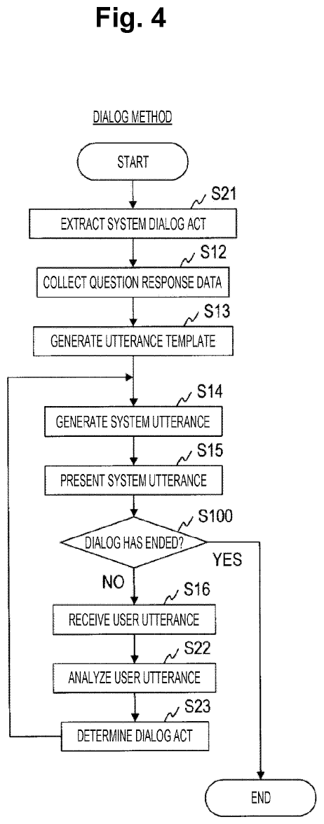

The second embodiment of the present invention is an example of a dialog device and a dialog method for presenting a system utterance for responding like the character A to an input user utterance in the frame-based task-oriented dialog system. As illustrated in FIG. 3, a dialog device 2 of the second embodiment includes the template storage unit 10, the question response collection unit 12, the template generation unit 13, the utterance generation unit 14, the utterance presentation unit 15, and the utterance reception unit 16 included in the dialog device 1 of the first embodiment, and further includes a dialog log storage unit 20, a dialog act extraction unit 21, an utterance understanding unit 22, and a dialog control unit 23. The dialog device 2 may include the voice recognition unit 18 and the voice synthesis unit 19 similarly to the dialog device 1 of the first embodiment. The dialog device 2 executes processing of each of steps illustrated in FIG. 4, whereby the dialog method of the second embodiment is implemented.

Hereinafter, the dialog method executed by the dialog device 2 of the second embodiment will be described focusing on differences from the first embodiment with reference to FIG. 4.

The dialog log storage unit 20 stores a dialog log when the user and the dialog device have a dialog. The dialog log includes a text representing a content of a user utterance, a text representing a content of a system utterance, and a label representing a system dialog act. The system dialog act represents an utterance intention of the system utterance and is a dialog act type of the dialog act of the system. The text representing the content of the user utterance is stored when the utterance reception unit 16 outputs the text representing the content of the user utterance. The text representing the content of the system utterance and the label representing the system dialog act are stored when the utterance generation unit 14 outputs the text representing the content of the system utterance.

In step S21, the dialog act extraction unit 21 acquires a list of system dialog acts from the dialog log stored in the dialog log storage unit 20, and outputs the acquired list of system dialog acts to the question response collection unit 12. Alternatively, a list of system dialog acts defined in the inside (for example, the dialog control unit 23) of the dialog device 2 may be acquired. In the present embodiment, it is assumed that three dialog acts of a “question about a place name”, a “question about a date”, and a “provision of weather information” are acquired as the system dialog acts.

In step S12, the question response collection unit 12 receives the list of system dialog acts from the dialog act extraction unit 21, collects question response data associated with each system dialog act from the online user, and outputs the collected question response data to the template generation unit 13. Specifically, first, the question response collection unit 12 adds each system dialog act as a tag to the question response collection site and makes the tag selectable on a posting screen. The online user selects a tag of any system dialog act on the question response collection site, and inputs a question that the character A would ask in the system dialog act and a response to the question. As a result, the question response collection unit 12 can acquire the question response data tagged with the system dialog act. For example, as a question about the system dialog act of the “question about a place name”, utterances are collected such as “Weather of where do you want to ask?” and “Of Where?”. As a question about the system dialog act of the “question about a date”, utterances are collected such as “When?” and “What day?”. In the system dialog act of the “provision of weather information”, utterances are collected such as “###!”.

In step S13, the template generation unit 13 receives the question response data from the question response collection unit 12, constructs an utterance template from the question response data associated with each system dialog act, and stores the utterance template in the template storage unit 10. The utterance template is a template for an utterance associated with each system dialog act. These are used when the system dialog act is uttered. Usually, it is assumed that a question included in the question response data is used as the utterance template, but a response may be used as the utterance template. Which one of the question and the response included in the question response data is used as the utterance template only needs to be determined in advance on the basis of a content of the dialog act. For example, the utterance template for the “question about a place name” is “Where is the place?”, the utterance template for the “question about a date” is “What day?”, and the utterance template for the “provision of weather information” is “Today's weather is ###”. Since the utterance template is simply a pair of a dialog act name and an utterance, the utterance template can be constructed by selecting a system dialog act and an utterance associated with the state from the collected question response data.

In step S14, the utterance generation unit 14 uses a system dialog act to be performed next as an input, acquires an utterance template associated with the system dialog act from utterance templates stored in the template storage unit 10, generates the text representing the content of the system utterance by using the acquired utterance template, and outputs the generated text representing the content of the system utterance to the utterance presentation unit 15. The system dialog act as an input is a predetermined dialog act (for example, “question about a place name”) in a case of the first execution from the dialog start, and is a system dialog act to be performed next output by the dialog control unit 23 described later in a case of the second and subsequent executions.

In step S22, the utterance understanding unit 22 receives the text representing the content of the user utterance from the utterance reception unit 16, analyzes the content of the user utterance, obtains the user dialog act representing an intention of the user utterance and an attribute value pair, and outputs the obtained user dialog act and attribute value pair to the dialog control unit 23. The user dialog act is a dialog act type of the dialog act of the user. In the present embodiment, it is assumed that there are three dialog acts of “transmission of a place name”, “transmission of a date”, and “transmission of a place name and a date” as the user dialog acts. For example, in the “transmission of a place name”, a place name is taken as an attribute. In the “transmission of a date”, a date is taken as an attribute. In the “transmission of a place name and a date”, both a place name and a date are taken as attributes. The user dialog act can be obtained by using a classification model learned by a machine learning method from data in which a dialog act type is assigned to an utterance. As the machine learning method, for example, logistic regression can be used, or a support vector machine or a neural network may be used. For extraction of the attribute, it is possible to use a model learned by a sequential labeling method (for example, conditional random fields) with constructed data in which labeling is performed of whether each word included in the utterance is a place name or a partial character string of a date. As a result, from an utterance of “It's tomorrow's weather”, the “transmission of a date” can be extracted as the user dialog act, and “date=tomorrow” can be extracted as the attribute value pair.

In step S23, the dialog control unit 23 receives the user dialog act and the attribute value pair from the utterance understanding unit 22, fills a frame defined in advance with the attribute value pair, determines a system dialog act to be performed next in accordance with a state of the frame, and outputs the determined system dialog act to the utterance generation unit 14. A method of determining the system dialog act is performed in accordance with, for example, a rule described in a form of If-Then. For example, in a case where the user dialog act is the “transmission of a date”, processing is described such as filling a slot of a “date” with an attribute of the date. In addition, if there is a slot not filled with a value in the frame, processing is described such as selecting a system dialog act of asking a question about the slot next. Here, behavior of the dialog control unit may be implemented not only by the If-Then rule but also by an Encoder-Decoder type neural network that obtains an output for an input, or reinforcement learning using a Markov decision process or a partially observable Markov decision process that learns an optimal action for an input.

### Specific Example of Second Embodiment

A specific example of the dialog executed by the dialog device 2 of the second embodiment will be described below. According to the second embodiment, it is possible to construct a frame-based task-oriented dialog system for guiding weather information with a predetermined character-like utterance as described below. Note that a description in parentheses in the system utterance represents a system dialog act, and description in parentheses in the user utterance represents a user dialog act and an attribute value pair. A description after * is a comment for explaining operation of the dialog system.
System: Weather of where do you want to ask? (question about a place name) *Set as an initial utterance of the system
User: It's Tokyo. (transmission of a place name, place name=Tokyo)
System: When? (question about a date) User: It's tomorrow. (transmission of a date, date=tomorrow)
System: It's sunny! (provision of weather information)

### Third Embodiment

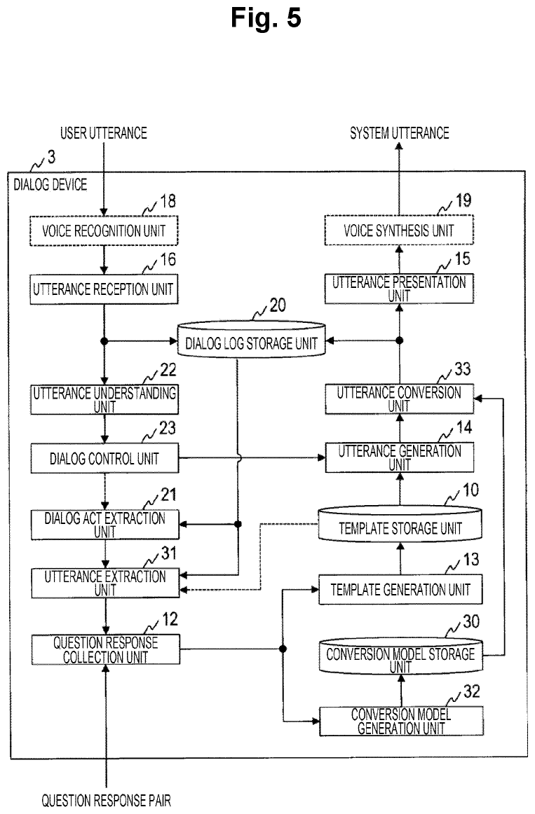

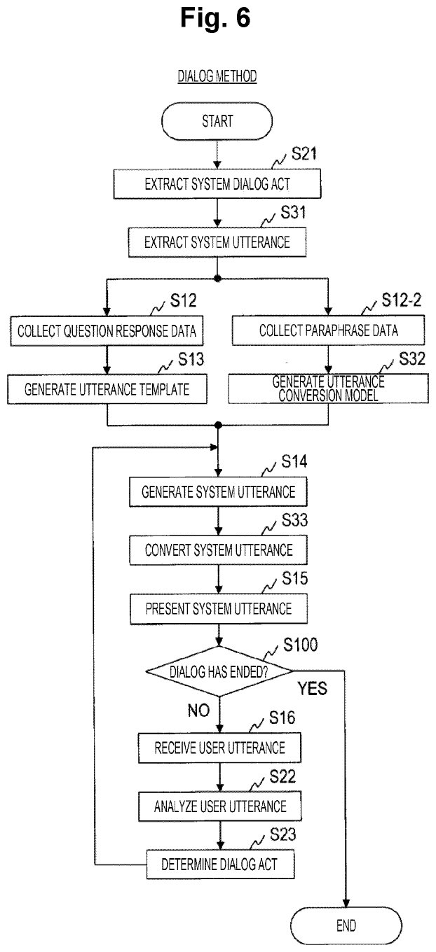

The third embodiment of the present invention is another example of a dialog device and a dialog method for presenting a system utterance for responding like the character A to an input user utterance in the frame-based task-oriented dialog system. As illustrated in FIG. 5, a dialog device 3 of the third embodiment includes the template storage unit 10, the question response collection unit 12, the template generation unit 13, the utterance generation unit 14, the utterance presentation unit 15, the utterance reception unit 16, the dialog log storage unit 20, the dialog act extraction unit 21, the utterance understanding unit 22, and the dialog control unit 23 included in the dialog device 2 of the second embodiment, and further includes a conversion model storage unit 30, an utterance extraction unit 31, a conversion model generation unit 32, and an utterance conversion unit 33. The dialog device 3 may include the voice recognition unit 18 and the voice synthesis unit 19 similarly to the dialog device 1 of the first embodiment. The dialog device 3 executes processing of each of steps illustrated in FIG. 6, whereby the dialog method of the third embodiment is implemented. Hereinafter, the dialog method executed by the dialog device 3 of the third embodiment will be described focusing on differences from the second embodiment with reference to FIG. 6.

In step S31, the utterance extraction unit 31 acquires a list of system utterances from the dialog log stored in the dialog log storage unit 20, and outputs the acquired list of system utterances to the question response collection unit 12. Alternatively, a list of system utterances that can be uttered by the dialog device 3 may be acquired from the inside (for example, the template storage unit 20) of the dialog device 3.

In step S12-2, the question response collection unit 12 receives the list of system utterances from the utterance extraction unit 31, collects a pair of each system utterance and a paraphrase utterance obtained by paraphrasing the system utterance (hereinafter, also referred to as “paraphrase data”) from the online user, and outputs the collected paraphrase data to the conversion model generation unit 32. Specifically, first, the question response collection unit 12 adds each system utterance as a tag to the question response collection site and makes the tag selectable on a posting screen. The online user selects a tag of any system utterance on the question response collection site, paraphrases the system utterance, and inputs an utterance that would be performed by the character A. As a result, the question response collection unit 12 can acquire the paraphrase utterance by the character A tagged with the system utterance. For example, a paraphrase utterance such as “Weather of where do you want to ask?” is collected for “Where is the place?” that is a system utterance of a system dialog act of the “question about a place name”.

In step S32, the conversion model generation unit 32 receives the paraphrase data from the question response collection unit 12, learns an utterance conversion model that paraphrases an utterance using the tagged system utterance and the paraphrase utterance input by the online user as pair data, and stores the learned utterance conversion model in the conversion model storage unit 30. As the utterance conversion model, for example, a model of Seq2Seq by a neural network can be used. Specifically, a BERT model is used for an encoder and a decoder, and OpenNMT-APE is used as a tool. This tool can construct a generative model that generates an output utterance for an input from utterance data of a tokenized pair. Note that the utterance conversion model may be learned by other methods, for example, a method using a recursive neural network. BERT and OpenNMT-APE are detailed in Reference Literatures 1 and 2 below.
[Reference Literature 1] Jacob Devlin, Ming-Wei Chang, Kenton Lee, Kristina Toutanova, “BERT: Pre-training of Deep Bidirectional Transformers for Language Understanding,” Proceedings of the 2019 Conference of the North American Chapter of the Association for Computational Linguistics, 2019.
[Reference Literature 2] Gon, calo M. Correia, Andre F. T. Martins, “A Simple and Effective Approach to Automatic Post-Editing with Transfer Learning,” Proceedings of the 57th Annual Meeting of the Association for Computational Linguistics, 2019.

In step S33, the utterance conversion unit 33 receives a text representing a content of the system utterance from the utterance generation unit 14, inputs the text representing the content of the system utterance to the utterance conversion model stored in the conversion model storage unit 30, obtains a text representing a content of a converted system utterance obtained by paraphrasing the system utterance, and outputs the obtained text representing the content of the converted system utterance to the utterance presentation unit 15.

The utterance presentation unit 15 of the third embodiment receives the text representing the content of the converted system utterance from the utterance generation unit 14, and presents the text representing the content of the converted system utterance to the user by a predetermined method as the text representing the content of the system utterance.

### Specific Example of Third Embodiment

A specific example of the dialog executed by the dialog device 3 of the third embodiment will be described below. According to the third embodiment, it is possible to construct a frame-based task-oriented dialog system for guiding weather information with a predetermined character-like utterance as described below. Note that a description in parentheses in the system utterance represents a system dialog act, and description in parentheses in the user utterance represents a user dialog act and an attribute value pair. A description after * is a comment for explaining operation of the dialog system.
System: Weather of where do you want to ask? (question about a place name) *Set as an initial utterance of the system
User: It's Tokyo. (transmission of a place name, place name=Tokyo)
System: When? (question about a date) *“When is it?” is paraphrased as “When?”
User: It's tomorrow. (transmission of a date, date=tomorrow)
System: It's sunny! (provision of weather information) *Paraphrase “It's sunny” to “It's sunny!”

### Advantageous Effects of Invention

According to the present invention, even if there is a small amount of question response data that can be collected from the online user, the system utterance is generated on the basis of the state or the dialog act that is the internal expression of the dialog system, so that it is possible to present an appropriate system utterance depending on the situation of the dialog. If the specific character-like utterance is collected from the online user, it is possible to impart the character-ness to an existing dialog system, and it is not necessary for a system developer to recreate the utterance generation unit for a target character. In addition, by collecting the question response data associated with the state of the dialog system or the dialog act and combining the question response data with the transition of the state or the dialog act of the dialog system in advance, it is possible to perform interaction that surpass interaction having one question and one response and is like a character.

While the embodiments of the present invention have been described above, a specific configuration is not limited to these embodiments, and it goes without saying that an appropriate design change or the like not departing from the gist of the present invention is included in the present invention. The various types of processing described in the embodiments may be executed not only in chronological order in accordance with the described order, but also in parallel or individually depending on the processing capability of a device that executes the processing or as necessary.

### [Program and Recording Medium]

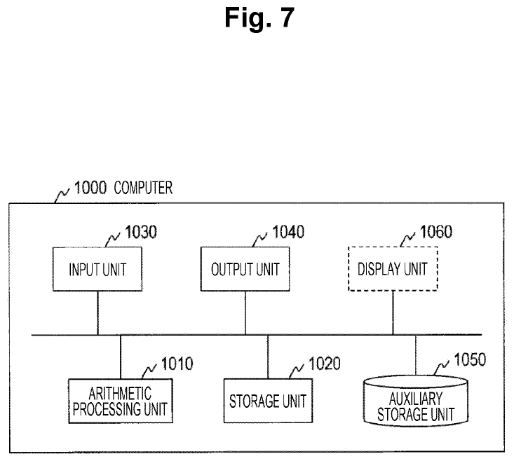

In a case where various types of processing functions in each device described in the embodiments are implemented by a computer, processing content of the functions of each device is described by a program. Then, by causing a storage unit 1020 of a computer illustrated in FIG. 7 to read this program and causing an arithmetic processing unit 1010, an input unit 1030, an output unit 1040, and the like to execute the program, the various types of processing functions in each device are implemented on the computer.

The program describing the processing content can be recorded on a computer-readable recording medium. The computer-readable recording medium is, for example, a non-transitory recording medium, and is a magnetic recording device, an optical disc, or the like.

In addition, distribution of the program is performed by, for example, selling, transferring, or renting a portable recording medium such as a DVD or a CD-ROM on which the program is recorded. Further, a configuration may also be employed in which the program is stored in a storage device in a server computer and the program is distributed by transferring the program from the server computer to other computers via a network.

For example, the computer that executes such a program first temporarily stores the program recorded in the portable recording medium or the program transferred from the server computer in an auxiliary storage unit 1050 that is a non-transitory storage device of the computer. In addition, when executing processing, the computer reads the program stored in the auxiliary storage unit 1050 that is a non-transitory storage device of the computer, into the storage unit 1020 that is a temporary storage device, and executes processing according to the read program. In addition, as another execution form of the program, the computer may directly read the program from the portable recording medium and execute processing according to the program, and the computer may sequentially execute processing according to a received program each time the program is transferred from the server computer to the computer. In addition, the above-described processing may be executed by a so-called application service provider (ASP) type service that implements a processing function only by an execution instruction and result acquisition without transferring the program from the server computer to the computer. The program in the present embodiment includes information used for a process by an electronic computer and equivalent to the program (data or the like that is not a direct command to the computer but has a property that defines processing by the computer).

In addition, although the present device is configured by executing a predetermined program on the computer in the present embodiment, at least part of the processing content may be implemented by hardware.

1. A dialog device comprising a processor configured to execute operations comprising:
collecting question response data, the question response data including a state of a dialog, a question, and a response;
generating an utterance template associated with the state on a basis of the question response data;
generating a system utterance by using the utterance template associated with a state of a current dialog;
presenting the system utterance to a user;
receiving a user utterance uttered by the user; and
causing causes the state of the current dialog to transition on a basis of the user utterance.

2. A dialog device comprising a processor configured to execute operations comprising:
collecting question response data including a first dialog act representing an utterance intention, a question, and a response;
generating an utterance template associated with the first dialog act on a basis of the question response data;
generating a system utterance by using the utterance template associated with a second dialog act to be performed next;
presenting the system utterance to a user;
receiving a user utterance uttered by the user; and
determining the second dialog act to be performed next on a basis of the user utterance.

3. The dialog device according to claim 2, the processor further configured to execute operations comprising:
learning an utterance conversion model that uses an utterance as an input and outputs an utterance obtained by paraphrasing the utterance, by using paraphrase data including the system utterance and an utterance obtained by paraphrasing the system utterance; and
inputting the system utterance into the utterance conversion model to obtain a converted system utterance obtained by paraphrasing the system utterance.

4. The dialog device according to claim 3, the processor further configured to execute operations comprising:
presenting an utterance presentation unit that presents the converted system utterance to a user.

5. (canceled)

6. A dialog method comprising:
collecting question response data including a first dialog act representing an utterance intention, a question, and a response;
generating an utterance template associated with the first dialog act on a basis of the question response data,
generating a system utterance by using the utterance template associated with a second dialog act to be performed next;
presenting the system utterance to a user;
receiving a user utterance uttered by the user;
determining the second dialog act to be performed next on a basis of the user utterance.

7. The dialog method according to claim 6, further comprising:
collecting paraphrase data, the paraphrase data including the utterance and a paraphrased utterance obtained by paraphrasing the utterance;
learning the utterance conversion model that uses an input utterance as an input and outputs an output utterance obtained by paraphrasing the input utterance, by using the paraphrase data,
inputting the system utterance into the utterance conversion model to obtain a converted system utterance obtained by paraphrasing the system utterance;
presenting the converted system utterance to a user;

8. (canceled)

9. The dialog device according to claim 1, wherein the utterance is in natural language form.

10. The dialog device according to claim 1, wherein the generated utterance template enables a type of phrasing that represents a human-like character of the dialog device.

11. The dialog device according to claim 2, wherein the utterance is in natural language form.

12. The dialog device according to claim 2, wherein the generated utterance template enables a type of phrasing that represents a human-like character of the dialog device.

13. The dialog device according to claim 3, wherein the paraphrase data indicates human character-likeness of the dialog device.

14. The dialog method according to claim 6, wherein the utterance is in natural language form.

15. The dialog method according to claim 6, wherein the generated utterance template enables a type of phrasing that represents a human-like character in the system utterance.

16. The dialog method according to claim 7, wherein the paraphrase data indicates human character-likeness in the converted system utterance.
